(19) United States
(12) Patent Application Publication
(10) Pub. No.: US 2005/0120356 A1
(43) Pub. Date: Jun. 2, 2005

(54) Distributing components across resources

(76) Inventors: Guillaume Mecheneau, Paris (FR); Julio Cesar Guijarro, Bristol (GB); Patrick Goldsack, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/939,926

(22) Filed: Sep. 13, 2004

(30) Foreign Application Priority Data
Oct. 31, 2003 (GB) 0325449.7

(51) Int. Cl. G06F 7/00; G06F 17/00

(52) U.S. Cl. 719/315

(57) ABSTRACT

A system and method for distributing components across a plurality of resources is disclosed. Briefly described, one embodiment of distributing components across a plurality of resources in which the location of objects is limited by one or more constraints comprises providing a model which comprises at least one resource object and at least one component object, each object having at least one property which causes the object to attract or repel other objects, wherein properties allocated to the objects are dependent upon the constraints which apply to distribution of the components across the resources; distributing the objects within a model space; allowing the objects to move within the model space towards a stable solution; and distributing the components within the model space according to the distribution of the objects in the model space.

### TECHNICAL FIELD

This invention relates to methods and apparatus for distributing components across a plurality of resources defining a multi-dimensional space in which the location of the components is limited by one or more constraints.

### CLAIM TO PRIORITY

This application claims priority to copending United Kingdom utility application entitled, “DISTRIBUTED COMPONENTS ACROSS RESOURCES,” having serial no. GB 0325449.7, filed Oct. 31, 2003, which is entirely incorporated herein by reference.

### BACKGROUND

There are many instances of problems, which require for their solutions components to be distributed across a plurality of resources. One example of such a problem is the allocation of software programs across a network of computer resources. In this problem, the components are the software programs and the space of the network of resources. In order to distribute the software, a number of externally applied constraints or rules must often be applied. An example of such a constraint or rule is that the computational load that is to be placed on each of the processors of the network should be as even as possible, necessitating a wide distribution of the software. On the other hand, some software components may have a requirement for high speed communication between one another. This introduces a constraint or rule that the software components should be located on processing resources, which are close together on the network if possible.

It is to be noted that in each case the constraints may apply to a property of the components, such as the memory requirements of the software. Additionally, or alternatively, they may apply to properties of the space in which they are distributed. For example, the speed of the computing resources defining the space to which the components are to be distributed.

In the past, the distribution of components in a multi-dimensional space has been performed by trial and error. In the above example, a network administrator responsible for distributing software across a network of resources could place a new piece of software on any processor and then run the network to see how it performs.

Any simple problem in which components are distributed across a space can be solved using trial and error in this way. However, this will not generally lead to an optimal solution. As the complexity of the problem increases then the problem becomes harder to solve. Introducing more than one type of constraint and more than two dimensions to the space can rapidly lead to problems which cannot readily be solved using trial and error.

### SUMMARY

One embodiment of distributing components across a plurality of resources in which the location of objects is limited by one or more constraints comprises providing a model which comprises at least one resource object and at least one component object, each object having at least one property which causes the object to attract or repel other objects, wherein properties allocated to the objects are dependent upon the constraints which apply to distribution of the components across the resources; distributing the objects Within a model space; allowing the objects to move within the model space towards a stable solution; and distributing the components within the model space according to the distribution of the objects in the model space.

Another embodiment of allocating portions of data across a network of computer resources comprises providing a model of the network of computer resources in which each resource is represented by an object in a space, the model having at least one data object which represents a portion of the data; determining from the forces exerted on the data object within the space whether the location of the objects is a solution to a problem of distribution; and in the event that it is a solution, allocating the portion of data to the resources according to the location of the objects in the model.

Another embodiment of allocating calls across displays of a call centre comprises providing a virtual model in which each display is represented by a physical object in a multi-dimensional space, the virtual model also including at least one call object which represents a call to a network; determining from the forces exerted on the call object within the space whether the location of the call object is a solution to a problem of distribution; and in the event that it is a solution, allocating the call to the display which corresponds to the display object that is closest to the call object in the virtual model.

Yet another embodiment is a call request display apparatus for use by a group of call receivers at a call centre to distribute comprising a plurality of display screens, a model of the displays in which each display is represented by a display object in a multi-dimensional space and the call is also modelled as a call object within that space, and a solution determining means for determining if the location of the call object in the space of displays provides a suitable distribution of the call on the displays.

### BRIEF DESCRIPTION OF THE DRAWINGS

The components in the drawings are not necessarily to scale relative to each other. Like reference numerals designate corresponding parts throughout the several views.

FIG. 1 is a general view of a system comprising a number of components which are to be distributed across a number of resources;

FIG. 2 is general view of the construction of a model of the system of FIG. 1;

FIG. 3 illustrates in more detail an example of a network of resources across which a plurality of portions of data defining computational processes are to be distributed;

FIG. 4 illustrates a model generated when carrying out an embodiment of a method in accordance with the present invention to distribute three processes on a two resource system of the kind shown in FIG. 3;

FIG. 5 illustrates the sum of forces one of the resource objects in the model of FIG. 4;

FIG. 6 illustrates the movement of the process objects due to a sum of forces towards a stable position as the model is allowed to evolve over time;

FIG. 7 illustrates the location of the three process objects in the model of FIG. 4 once a stable state has been reached;

FIG. 8 illustrates the effect of allowing charge to transfer from a process object to a resource object;

FIG. 9 illustrates a model in which additional springs have been added;

FIG. 10 illustrates the layout of a call centre apparatus for distributing incoming calls across a set of display screens;

FIG. 11 is a flowchart illustrating an embodiment of a process of distributing components across a plurality of resources;

FIG. 12 is a flowchart illustrating another embodiment of a process of allocating portions of data across a network of computer resources; and

FIG. 13 is a flowchart illustrating an embodiment of a process of allocating calls across displays of a call centre.

### DETAILED DESCRIPTION

One embodiment provides a method of distributing components across a plurality of resources in which the distribution of the components is limited by one or more constraints, the method comprising the steps of:
(a) providing a virtual model which comprises at least one resource object modelled as an object to which is allocated at least one property which causes the object to attract or repel other objects within the space, and at least one component object which is also modelled as an object to which is allocated at least one property which causes the object to attract or repel other objects within the space, the properties allocated to the objects being dependent upon the constraints which apply to the distribution of the components across the resources;
(b) distributing the objects within a multi-dimensional model space;
(c) allowing the objects to move within the space towards a stable solution; and
(d) distributing the components within the multi-dimensional space according to the distribution of the objects in the model.

The resource and component objects may be modelled with many different types of property to represent different constraints on the distribution. In each case, the types and values of properties which are chosen determine which constraints apply to a component and in which way.

Another property which may be applied by some embodiments to an object is to apply a charge to it, such as an electrostatic or magnetic charge. The application of a charge will cause objects to which a charge is applied to interact, producing forces on the objects, which will tend to cause them to move in the model space until a stable solution is reached. This movement simulates the effect of constraints. An alternative is to apply a mass to an object. Two objects with a mass will interact as the mass causes the object to produce its own gravitational field. A still further property is to apply heat to an object giving it a temperature.

A combination of these properties may be applied, an object having both a charge and a mass for example. Also, an object may have more than one type of charge or mass applied to it, with only objects having charges or masses of the same type interacting. An object could have two types of mass, each type causing it to interact with other objects with that same mass type. A similar step can be performed with charges, an object having more than one type of charge allocated to it. Each type of mass or charge can be chosen to model a particular type of constraint.

Other properties may also, or alternatively, be applied to objects by various embodiments. For example, two objects may be connected by one or more interconnecting members to link them together either loosely or rigidly within the model space. For example, a spring may be provided between two objects to connect them together. This applies a property to the two objects such that they are connected in the space. Forces applied to the objects may stretch or compress the spring. The higher the spring constant, the more force will be needed to move the objects apart or closer together. A higher spring constant could be used, for example to represent a constraint that two objects are kept close together, a low spring constant being chosen if the objects should be kept together but where it is less important that this is so.

In some embodiments, interconnecting members could also be used to anchor an object to a fixed point in the model space as well as or instead of anchoring it to other objects. Such a link, which again could be a spring or could be a rigid link, will constrain an object to a particular space. This embodiment could be used, for example, to define the location of resources, which form a fixed network of interconnected resources to define the fixed topology of the network. It could be used where the system is a flow of work to indicate that a resource is only available at a fixed time within a space that comprises a period of time within which work components can be undertaken.

Generally, the type of property applied should be chosen according to one type of constraint, the magnitude of the property applied being selected according to the property of the actual component on which the constraint is to act.

Other embodiments may provide a method of distributing components using a virtual model of the components which are allowed to move towards an optimal solution under forces which represent the constraints. By giving each object in the model a property which is dependent upon a feature of a resource or a component that is controlled by the real-world constraints, a solution to the problem of distribution is found by simply allowing the model time to move towards a stable position.

Some embodiments of the model may have more than one dimension in which each dimension in the space corresponds to a different constraint. It may have two dimensions, but most likely three or four or more for distributing many objects under a complex set of constraints. For four constraints, the model may be considered to have four dimensions. Of course, more than one constraint may apply in any given dimension.

The following examples may be used to help understand how an exemplary embodiment of a method can be implemented. The provision of a virtual model with charged objects is used as an example of a property type.

Two components may be given a charge of the opposite polarity if they need to satisfy a constraint that they are located close to one another in the space. An example of a need for such a location is the allocation of two software programs on a network of processors which require rapid communication between them. In this case, both components may be given a charge of opposite sign.

On the other hand, they may be given charges of the same polarity to satisfy a constraint that they are to be located far away within the space. An example of such a constraint would be the allocation of two software programs to a network in which the programs clash if they attempt to take resources from the same part of the network.

The magnitude of the property (in this example the amount of charge) allocated to each object in the model may be chosen according to the size or significance of the parameter which is constrained. Giving an object a higher magnitude of charge means it will be more constrained than an object of lower charge.

For example, in the case of the distribution of software components across a space in which several programs should be located close on a network, then those components which have a greater need to be close to one another may be represented in the model by charges which are given a higher charge than those for which it is not as important.

Of course, it should be understood that the various embodiments are not limited to the charges in which opposites attract. The objects in some embodiments could be given a property such as mass in which all objects with a mass of the same type attract one another.

Some embodiments may provide for more than one type of property to be applied to an object representing a resource or a component so as to allow for distribution in which several different constraints apply.

For example, objects in an embodiment may be given both a mass and a charge to enable the method to solve a distribution problem in which two different constraints apply. The charge may represent one property subject to a constraint, the mass another. Both electromagnetic and gravitational forces will then be exerted between objects at the same time.

Of course, not all objects need be subject to both constraints. One object may therefore only be given a mass and no charge, the other object a charge but no mass. Again, charge and mass are only examples of two different properties that apply. Springs could also be used to represent a second, or perhaps even a third constraint.

It should also be understood that different types of a property may be applied, such as different masses or charges, in other embodiments.

It is envisaged that there would be no limit on the number of constraints that can be modelled in this way.

A benefit of some embodiments is the use of more than one type of property which interact between components to represent a constraint, such as a charge force, or a mass or a spring. Such constraints may cause objects to interact with other objects in different ways. A charge may be allocated to a component according to one property which is constrained by the attraction/repulsion forces in the model. A mass may be allocated to the component according to a different property which is constrained by the forces generated by one or more springs between the component and other components.

It should be understood that some embodiments do not require the model to be a physical model in the sense that actual physical objects with, say mass and charge have to be arranged in physical space. Some embodiments are a virtual model which uses simulated objects and places them in a simulated space, and would most likely be used to perform the method using a computer program running on a processor.

Therefore, some embodiments provide a computer program which, when running on a processor, causes the processor to perform the method of the first aspect of the invention.

Some embodiments provide a method of allocating portions of data across a network of computer resources, the method comprising:
providing a virtual model of the network of resources in which each resource is represented by an object in a multi-dimensional space, the model also including at least one data object which represents a portion of data; and
   determining from the forces exerted on the data object within the space whether the location of the component is a solution to the problem of distribution; and
in the event that it is a solution, allocating the portion of data to the resources according to the location of the objects in the model.

The data portions in some embodiments may comprise computer programs which are to be stored in memory. They may be other types of data, such as information held in a database or any other form.

The method may, for one exemplary embodiment, more specifically include the following steps:
receiving a portion of data defining a computational process;
determining at least one property of a resource required by the process; and
modelling the process as a component in which the properties allocated to the object corresponds to the property of the resource required by the process.

In some embodiments, the property of the resource required by the process may comprise an amount of memory for storage of the process, processor speed, connections to other resources etc.

Other resource objects may also have properties according to the amount of storage they provide, speed etc., depending upon the embodiments. The same function may be used to allocate properties to the resource objects and the process objects in some embodiments.

The object may be placed in the space of resources at a random location or at a preset location in some embodiments.

An exemplary embodiment may comprise, after locating the data object the steps of determining if the component is in a stable state; and
(a) in the event that it is in the stable state, allocating the process to the resource which corresponds to the resource object closest to the data object in the model space;
(b) in the event that it is not stable, allowing the model to evolve over time such that the component moves towards a stable state and then allocating the process to the resource corresponding to the resource object which is closest to the data object in the model space.

Embodiments may be extended or modified to take into consideration additional or other constraints, such as the amount of additional storage a process demands from a resource as well as or instead of, the speed of the processor and any network connections it may have.

Some embodiments may, for example, allocate a mass and or charge to each resource object in the model according to its processing speed, and a mass and or charge to the process according to the speed it requires. Gravitational forces will then apply between the masses which models the constraint of speed requirements.

Additionally, in some embodiments, one or more springs may be placed in the model between a resource and a process request. The springs will also exert a force between components which models a constraint. For instance, a job may be connected by a spring to its preferred resource. It will then be allocated to that resource as it is held by the spring unless the other constraints pull it away towards another resource.

It is envisaged that in some embodiments the data portion may be identified by a job request, the job request defining the requirements of a job. The method will most likely be performed by a network administrator or administration device, perhaps receiving requests received by a server across a remote network such as the internet.

Some embodiments provide apparatus for allocating data portions across computer devices connected to form a network of resources, the apparatus comprising a model of the network of resources in which each resource is represented by an object in a multi-dimensional space and the data portion is also modelled as a data portion within that space, the apparatus including solution determining means for determining if the location of the data object in the space of resources provides a suitable distribution of the data portion across the network.

Another embodiment provides a method of allocating calls across displays of a call centre, the method comprising providing a virtual model in which each display is represented by an object in a multi-dimensional space, the model also including at least one call object which represents a call to the network, and
determining from the forces exerted on the call object within the space whether the location of the call object is a solution to the problem of distribution; and
in the event that it is a solution, allocating the call to the display which corresponds to the display object that is closest to the call object in the model.

Another embodiment provides a call request display apparatus for use by a group of call receivers at a call centre to distribute calls, the apparatus comprising a plurality of display screens, the apparatus further comprising a model of the displays in which each display is represented by a display object in a multi-dimensional space and each call is also modelled as a call object within that space, the apparatus including solution determining means for determining if the location of the call object in the space of displays provides a suitable distribution of the call on the displays.

Each display may comprise a separate display unit, such as a monitor screen allocated to a call operator. It could, alternatively be a page within a set of pages that a call operator can select.

Calls may be allocated according to the type, timing, content, duration or outcome of the call. Each of these parameters may be constrained. Thus, each call object and display object in the model may be given at least one physical property that corresponds to its weighting in respect of one constraint.

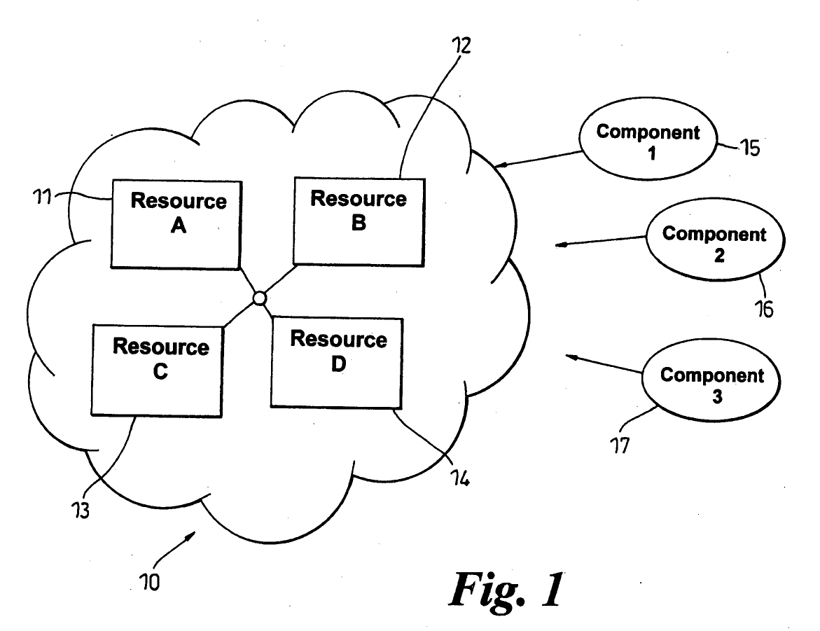

A system 10 in which components can be distributed, according to one embodiment of a method, is illustrated in general terms in FIG. 1 of the accompanying drawings. The system comprises a set of resources A-D labelled 11,12,13 and 14, and a set of components 15,16 and 17 that are to be distributed across the resources. The resources and components could be many things, and several specific examples are shown in the remaining drawings. Keeping to a very generalised description, however, the resources can be thought of as devices or areas which define space in which components can be located, whilst the components are objects or jobs which need to be placed in a location. The “space” occupied by the resources could be an area, such as part of a display or memory. Alternatively, the term “space” could mean space in some other sense such as a capacity within a system to do work or to perform a task or function or slots of time in a schedule.

The exemplary embodiment distributes the components within the space by defining a model of the system and allowing the model to naturally evolve to produce a solution. The model relies upon providing a set of charges which represent each resource and component. The charges interact with each other exerting forces between the objects. By careful selection of the forces to represent the constraints under which the components and resources are to be distributed, the model will naturally move to a stable position which represents a distribution that satisfies the constraints. The actual components can then be distributed in the manner set out by the model.

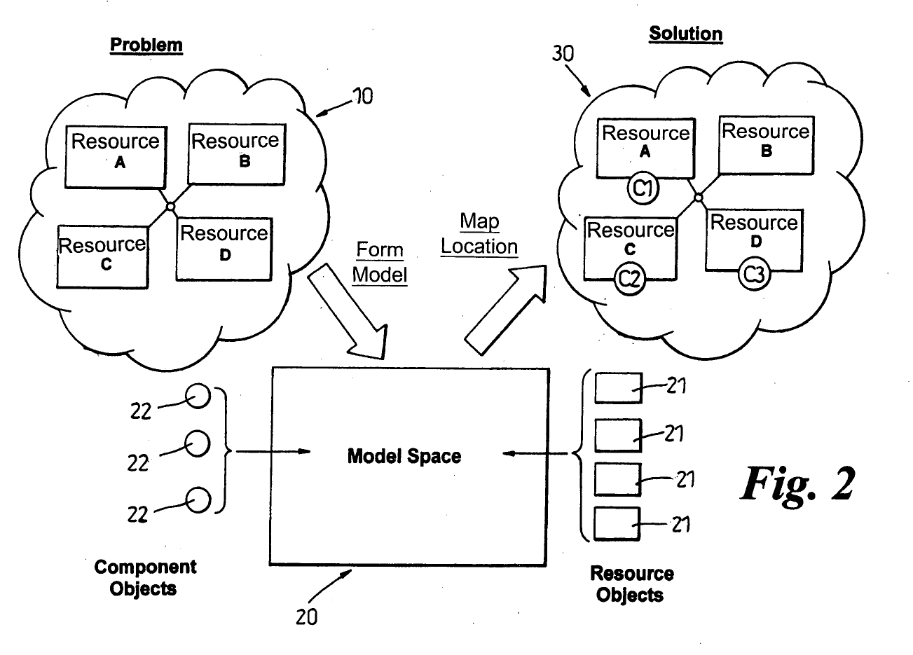

The relationship between the system 10, a model 20 and the solution 30 is illustrated in FIG. 2 of the accompanying drawings. As can be seen, the resources are each mapped to a charged object 21 in the model, as are the components 22. The model objects are allowed to move to a stable position, and finally the position of the objects in the model is used to define the position of the actual components and resources in the system.

The following description explains an exemplary embodiment in more detail by way of outlining several examples of more specific alternative embodiments which fall within the scope of the disclosure.

### EXAMPLE A

### Distribution of Software Components on a Network

In this exemplary embodiment, a number of data portions defining computational processes or software components are to be distributed across a network of resources.

Each resource comprises a server. Each server, comprises a processor and an area of associated memory. The processors are connected to form a network. The software components can be located on any host which has enough free memory to store the component, and when executed each software component will take up a certain amount of the resources of the host processor.

A multi-dimensional space can therefore be defined for the network of hosts connected across the network, their location in the space being determined by the connections between resources. The software components can be considered to be components to be distributed across the network. The hosts may also be considered to be components in their own right, especially if the connection between the hosts can be varied. The constraints include the amount of space needed on a host to store the software, the speed of the processors needed to run a software component.

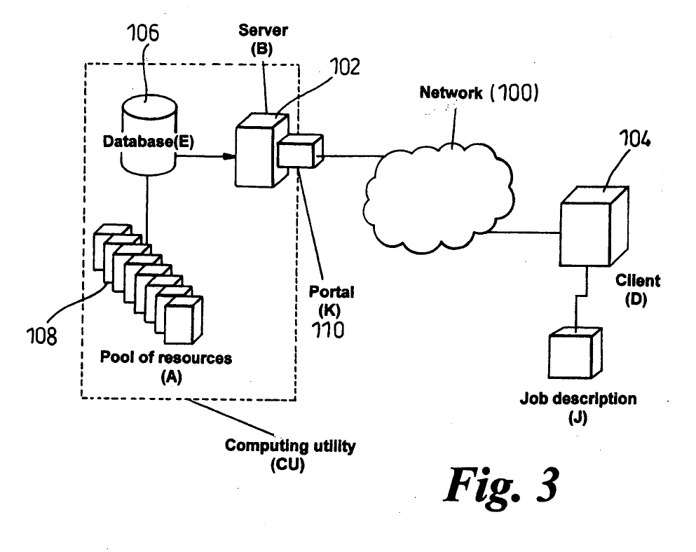

An exemplary network 100 is illustrated in FIG. 3 of the accompanying drawings.

Consider first the problem of distributing software components across the network. In the exemplary embodiment of FIG. 3, this task is performed by a computer program hosted by a server 102 which receives process distribution requests from a client 104. This program may comprise a computing utility (CU) which is able to allocate resources on demand from a pool of resources and configure the network for this set of resources. The CU may for example be a highly modified version of the Utility Data Centre available from Hewlett Packard or some similar CU. The problem in this case is the allocation of resources to an incoming application. As shown, a pool 108 of resource descriptions are stored in a database 106 provided on the server 102 of the CU. They may be stored by manually adding descriptions of resources, or by providing an automatic discovery mechanism to the CU using DHSCP for example.

One may want to know on which resources the software is to be stored and executed to make best use of the network when it has a limited capacity.

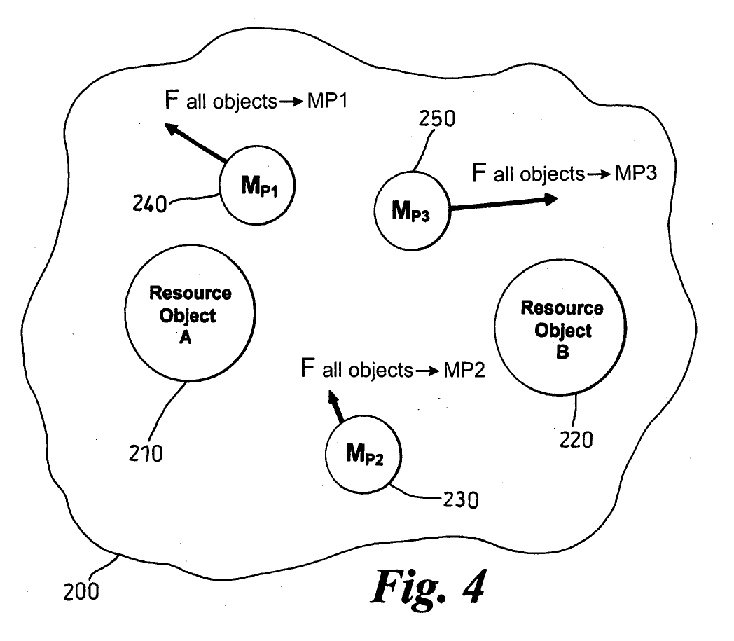

Implementing an embodiment method to solve this problem, we may first define a virtual model of the problem in which the resources are all modelled as physical objects which interact within a model space. This is shown in FIG. 4 of the accompanying drawings for a simple two resource, three process request to the system of FIG. 3. The server 102 (FIG. 3) is notified of updates on the database and converts the descriptions of the resources in the database into a model comprising of resource objects with charges in a plane space. The charges for each object are selected according to the memory of a resource, using predefined conversion functions (f1, f2).

We therefore represent each resource within a space 200 using a model in which a resource is represented by a physical object—in this case a charged component. To keep the example simple, only two resources or hosts will be considered—Resource A and Resource B offering memory Ma and Mb, respectively. They are shown as objects 210 and 220, respectively, in FIG. 4.

Having defined objects for all the resources 210, 220 and placed them in the space, the next stage is to receive a request for resources and to model the request as another physical object which can be placed in the space. To do so, the server 102 receives a job description which includes a job name and a memory requirement. This job is submitted to the CU through an internet portal 110 over the network 100 by a client 104 (FIG. 3) opening a connection to the portal and sending its credentials. Only if the credentials indicate that the client is allowed to submit the job is it accepted by the CU.

Having received a submitted job, the server translates the job request into a process object M in the model using the same conversion functions f1 and f2 used to model the resources. The memory requirements are converted into a charge value applied to the object.

Consider that N job requests or processes P1 . . . Pn are to be fitted onto the network each demanding or consuming amounts of memory Mp1 . . . Mpn. The problem to be solved is therefore how to map the N software components to the two resources A and B.

For such a simple problem (only 2 resources), a model is therefore constructed in which both resources and components are represented as objects (i.e. points of infinitely small size or areas/surfaces in space) in a multi-dimensional space. In both cases the memory requirements are represented by allocating a charge to the objects representing resources and an opposing charge to the objects representing components. Lets consider that the resources are allocated a positive charge and the components a negative charge although the reverse would also work.

The charges, resource objects and process objects, are then introduced into the multi-dimensional space as shown in FIG. 4 of the accompanying drawings. In this example, the resources 210, 220 are placed in fixed positions and they are anchored in place so they cannot move in the model. As such, they can exert forces on other charges but are not subject to forces themselves. They should be set in their final positions.

The process objects 230, 240, 250 are introduced into the space 200. They can be introduced at random locations or at predetermined locations in the space 200. The components are free to move around the space 200 under the influence of the charges of the fixed resources and other components, but are otherwise completely free to move.

The charge applied to a resource object is chosen according to how much memory it has, and the charge applied to a component is also chosen according to how much memory it needs. The forces that the charges produce therefore provide model of the constraints placed on the distribution due to the memory requirements.

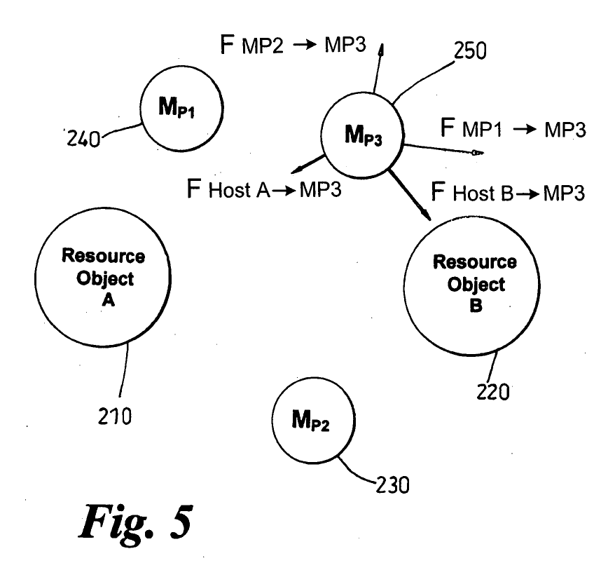

For each mobile object (by which we mean an object which is free to move in the space 200), the vector sum of the forces on a component are calculated. This is shown in FIG. 5 of the accompanying drawings. The forces are due to interactions with other mobile objects and the fixed resource objects. If at this stage the resultant force of forces applied to all the mobile objects is below a threshold acceptable level, then the position of the mobile objects is taken as a solution to the distribution problem. This indicates a stable solution has been reached. The actual software components can then be distributed to the actual resources in the way that the model objects are distributed.

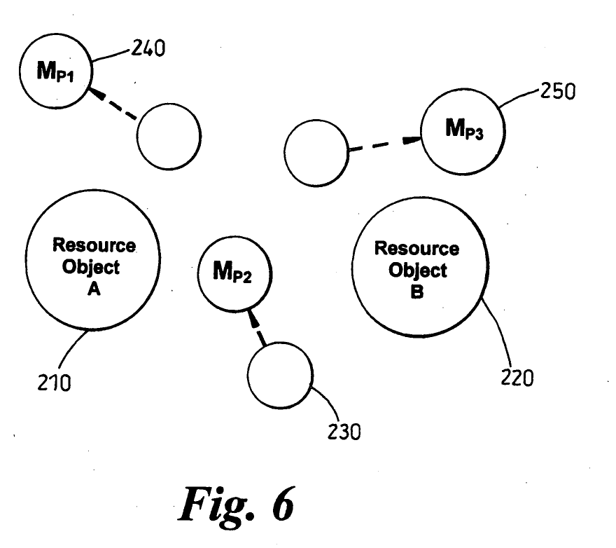

If the sum of forces on at least one mobile object exceeds the predetermined allowable level, then it can be assumed that the model is not in a stable state. In this case, the model is moved forward in time and the mobile objects are allowed to move through the space under the influence of the forces on the mobile objects. This is shown in FIG. 6 of the accompanying drawings.

After a predetermined elapsed time, the mobile objects are again frozen in space and the forces calculated to see if they indicate a stable state is reached. If not, then another time period is allowed to pass and so on.

In the event that a stable state is not reached after one or more time steps, the mobile objects may be rearranged at a new set of random start positions and the method repeated. The objects may be stopped so that their speeds are reset to zero to remove the effects of momentum. Otherwise, friction forces can be applied to the mobile objects to encourage them to reach a stable state.

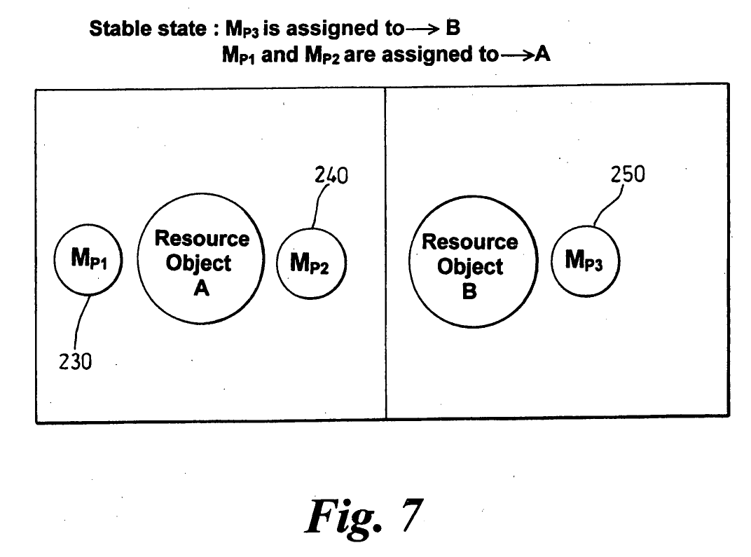

Each process object is assigned to resource object according to its final position as shown in FIG. 7 of the accompanying drawings. In this example, objects 230 and 240 are assigned to Resource A, with object 250 assigned to Resource B.

Several variants may be applied to the process. For example, the mobile objects may be introduced to the space one at a time, or several at a time, or all at the same time. If they are introduced one at a time or several at a time, then the order in which they are introduced may be chosen to reflect the priority with which they are to be distributed. In an alternative embodiment, the objects are released to move freely without interruption (but with damping of their motion) until they cease moving as a result of reaching a stable state—in other words the resultant force on each of the component objects is zero.

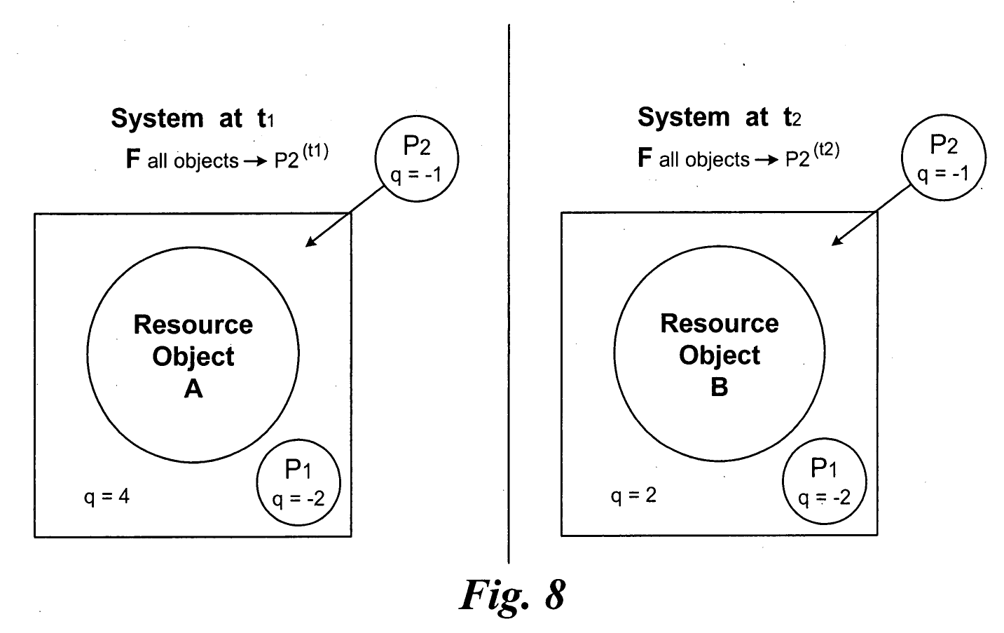

Charge may be transferred between a mobile object and its host once it has been allocated to a host. This reduces the attraction of the host to other mobile objects reduced later to the space to indicate its diminished capacity to store the new object. This is shown in FIG. 8 of the accompanying drawings.

Consider next a more complicated problem for distribution of software components across a network. In this problem two additional parameters and corresponding constraint are introduced. The first constraint is that of the storage requirements of a software component. The second is that of the network bandwidth required by a component.

The two additional constraints—each being a constraint on two new parameters, add two more dimensions to the problem.

To represent each constraint in the model, a set of objects (points or surfaces or area) with charges are again introduced. Now, we also give each object two different types of mass. One of the pair of masses is a mass dependent upon the storage requirements of the software component and the other its network bandwidth requirement. Only like masses are able to interact with each other. Thus masses which relate to bandwidth are only able to interact with other masses which relate to bandwidth; in other words, each mass is active in a different dimension.

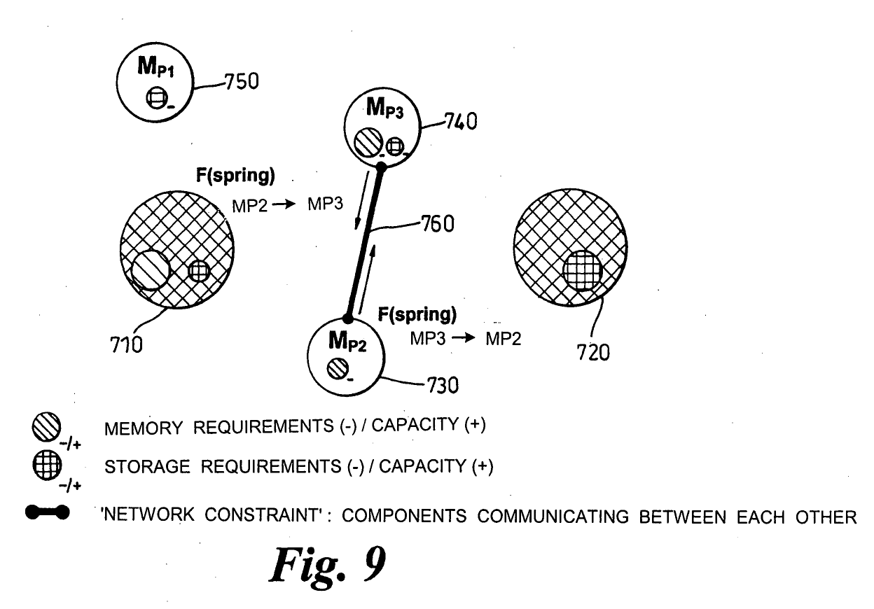

To introduce the constraints of memory requirement, storage and bandwidth to the model, springs are introduced between objects which exert a force according to the mass of the components and also the length and the strength of the springs. An example of such a model is shown in FIG. 9 of the accompanying drawings.

Having introduced a number of resource objects 710, 720 into a space containing the process objects 730, 740 and 750 as with the first, simple problem, a spring 760 is added to the system between two of the process objects. The system is again allowed to reach a stable state. The mobile objects will have forces exerted upon them by the charges and also the springs representing the two types of constraints.

The masses of the resources are positioned in the plane space by fitting them to the crossings of a grid of orthogonal lines. A system of co-ordinates is chosen for this space.

The server may perform the following:
a—Set a quantity of time T.
b—Place the object M in position P0 within the boundaries of the grid of computer masses (for example a random position within the convex envelope of the computer masses positions).
c—Sum up all gravity forces applied by masses in the system and all electromagnetic forces applied by all other charges in the system to obtain the total vector force Fext applied by the external system on this new mass. If Fext is smaller than fixed Feps go to step g.
d—Compute the new position reached by the object after the Fext force is applied during T seconds.
e—If the object has moved by a distance greater than the average distance between computer masses, reduce T by half and get back to b.
f—Go back to step c.
g—Fix the position of the object. Let Mc be the closest mass from M.
h—Start the job J on the computer Mc.

### EXAMPLE B

### Call Centre Call Display

In this exemplary embodiment, it is assumed that a call centre receives a large number of calls and wishes to route the calls to different operators depending upon the nature of the call that has been made. To inform an operator that a call has been allocated to them, each operator is provided with a display screen upon which the details of calls are displayed.

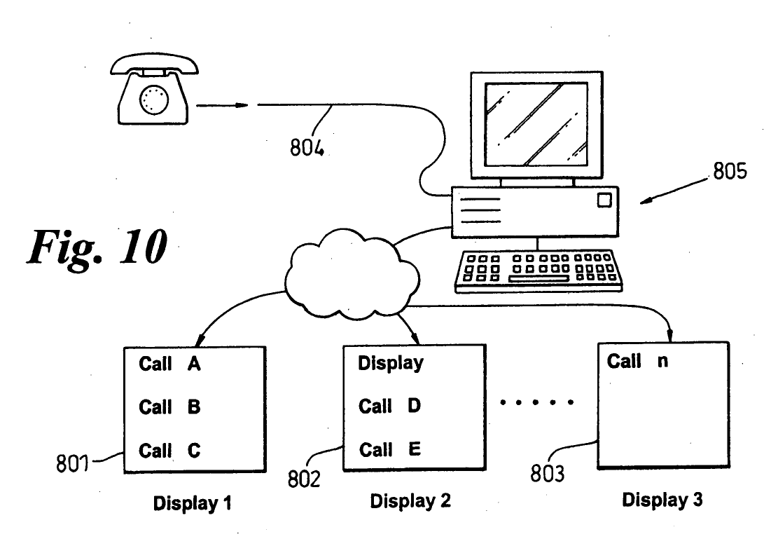

A suitable call centre apparatus is illustrated in FIG. 10 of the accompanying drawings. The apparatus comprises a plurality of n displays 801, 802, 803, at least one incoming telephone line 804 for receiving calls and a processing apparatus 805 which handles call information. Each display 801-803 is located on the workstation of a call operator and calls to be answered are displayed on the displays. The operators will have different roles, some perhaps filtering initial calls received at the centre with others taking technical calls after filtering or dealing with unresolved calls. There is therefore a need to distribute calls to the most suitable display according to its content, duration, time etc.

The processing apparatus 805 includes a processor which runs a computer program that causes the processor to produce the information that is to be sent to each display 801-803, and which also receives call information. This information may be extracted directly from a call or may be input to the processor by a call operator. They may enter the content of the call or information as to whether it needs an expert or is unresolved.

The components in this example that are to be distributed are therefore the incoming calls. The multi-dimensional space is the set of displays for all the operators, and the constraints are which display a call is to be shown in and where on the screen. This constraint may be applied to several properties of the calls such as the level of resolution of the call and the type of problem which the call relates to.

In this exemplary embodiment, the distribution of calls across the displays, a model space is first defined which contains a set of display spaces. Each display space may be connected by one or more hard edges and one or more connecting edges. A hard edge represents the boundary of the total area of screens. A connecting edge represents a boundary between displays. The set of display spaces may be split into groups, say three for first level support, two for second level support, one for expert level support, one for resolved calls and one for unresolved calls. Each display of the set is given a different charge according to its level.

When a new call is logged at the call centre, a charge of support level 1 is automatically assigned to a mobile object of a model of the system. Because of the interaction between the charge of the object and that of the displays in the space, when the component is placed in the space it will move to the appropriate display space. The attraction/repulsion of the charges models the constraints placed on the system.

Once an operator has attended a call which is present in his or her display, its status will change according to the outcome of the call. The charge of the object modelling the call is then changed to reflect its status so that it will result in the call being moved to the resolved or unresolved display space or a different level of support.

A feature of this embodiment is that it can be readily scaled to different sizes of systems with different numbers of displays. Adding another display to the space will result in a redistribution of the charges and hence calls to the different displays.

It will, of course, be understood that the described embodiments are not intended to limit the scope of the disclosure. Other embodiments, some of which require distribution, are envisaged such as the location of graphical information within a large display area to form a chart of connected information.

An example of a further distribution to which an embodiment can be applied is the representation of an application in two displays showing management components in one display and application operational components in the other.

In a first step, the display areas have to be defined and the elements involved in the display classified as visible elements and invisible elements.

Consider for example that two consecutive displays A and B are connected by a connection wall placed in the right side of A and in the left side of B. Consider also that two types of applications are defined: application type 1 management and application type 2 operational. These two types are represented by two different strong negative non-visual charges. The charge 1 representing management is placed in the centre of display A and the charge 2 representing operational components is placed in the centre of display B. Next we may introduce an application. The first application “a” is composed of a web server with charge operational, a monitoring component with charge management and a database component with charge operational. Each one of these is also given a positive wall charge so that they are repelled by the display walls and a charge defining the application type they belong to.

When the application “a” is introduced the management component will be attracted to the invisible charge at the centre of display A and the two operational components to the invisible charge in the centre of display B. The movement of the components to their final, stable positions could also be displayed.

In a still further embodiment, the method could be used to distribute virus monitors or agents or perhaps service level agreements around a computer system. Nonvisible charges could be placed in a model of the system to attract charged objects which represent the monitors or agents or the like. The placement of the non-visible charges governs the final distribution around the system, i.e. sets the constraints or rules that are to be applied.

In the case of virus monitors, for example, charges may be placed at points where viruses have previously been detected in order to provide greater protection at those points.

### Other Exemplary Embodiments

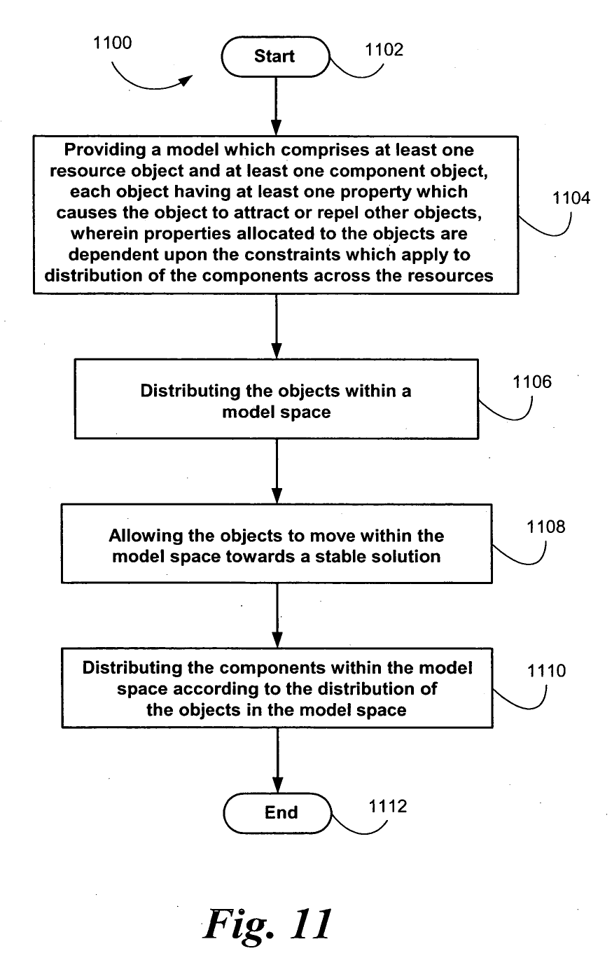

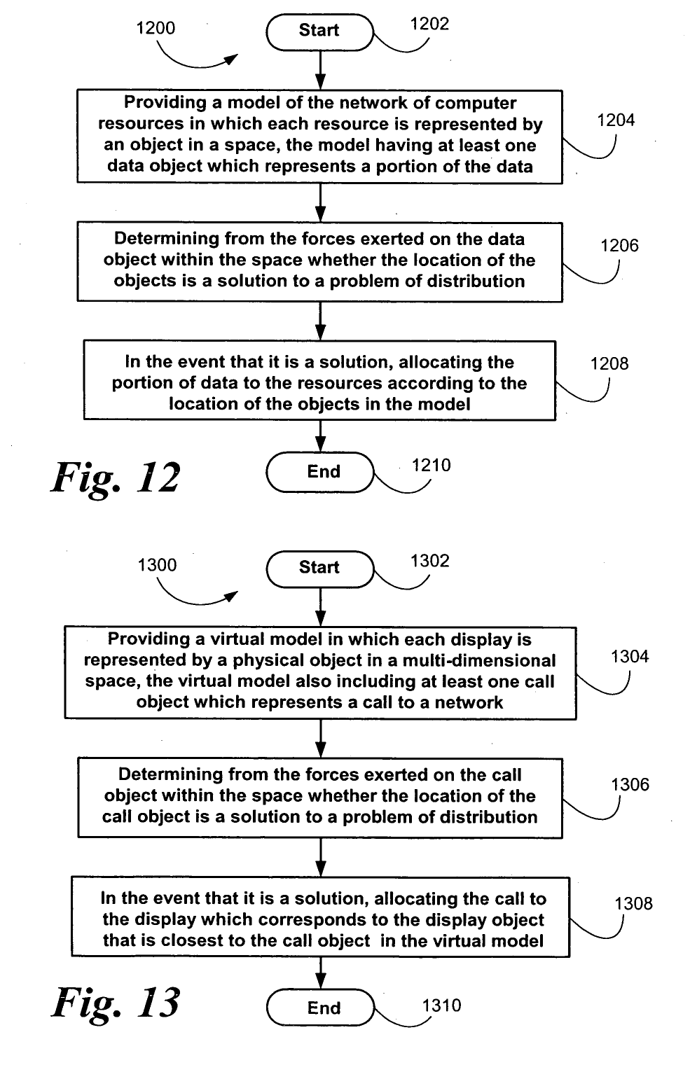

FIG. 11 is a flowchart illustrating an embodiment of a process of distributing components across a plurality of resources. FIG. 12 is a flowchart illustrating another embodiment of a process of allocating portions of data across a network of computer resources. FIG. 13 is a flowchart illustrating an embodiment of a process of allocating calls across displays of a call centre.

The flow charts 1100, 1200 and 1300 of FIGS. 11-13, respectively, show the architecture, functionality, and operation of various exemplary embodiments. Such embodiments may be implemented a logic executed by a processing system. Alternative embodiments implement the logic of flow charts 1100, 1200 and 1300 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIGS. 11-13, or may include additional functions. For example, two blocks shown in succession in FIGS. 11-13 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the disclosure.

With respect to the flow chart 1100 (FIG. 11), the process begins at block 1102. At block 1104, a model is provided which comprises at least one resource object and at least one component object, each object having at least one property which causes the object to attract or repel other objects, wherein properties allocated to the objects are dependent upon the constraints which apply to distribution of the components across the resources. At block 1106, the objects are distributed within a model space. At block 1108, the objects are allowed to move within the model space towards a stable solution. At block 1110, the components are distributed within the model space according to the distribution of the objects in the model space. The process ends at block 1112.

With respect to the flow chart 1200 (FIG. 12), the process begins at block 1202. At block 1204, a model is provided of the network of computer resources in which each resource is represented by an object in a space, the model having at least one data object which represents a portion of the data. At block 1206, it is determined from forces exerted on the data object within the space whether the location of the objects is a solution to a problem of distribution. At block 1208, in the event that it is a solution, the portion of data is allocated to the resources according to the location of the objects in the model. The process ends at block 1210.

With respect to the flow chart 1300 (FIG. 13), the process begins at block 1302. At block 1304, a virtual model is provided in which each display is represented by a physical object in a multi-dimensional space, the virtual model also including at least one call object which represents a call to a network. At block 1306, it is determined from the forces exerted on the call object within the space whether the location of the call object is a solution to a problem of distribution. At block 1308, in the event that it is a solution, the call is allocated to the display which corresponds to the display object that is closest to the call object in the virtual model. The process ends at block 1310.

Other embodiments may be used to distribute graphical information on a display with the information being connected by lead lines to form a flowchart or family tree or the like. The lines and also the graphical information could be modelled as objects with properties applied. For instance the method could be used to lay out the information in such a way that the lines do not cross by giving each interconnecting line a charge in the model causing them to repel one another.

1. A method of distributing components across a plurality of resources in which the location of objects is limited by one or more constraints, the method comprising:
providing a model which comprises at least one resource object and at least one component object, each object having at least one property which causes the object to attract or repel other objects, wherein properties allocated to the objects are dependent upon the constraints which apply to distribution of the components across the resources;
distributing the objects within a model space;
allowing the objects to move within the model space towards a stable solution; and
distributing the components within the model space according to the distribution of the objects in the model space.

2. The method of claim 1, wherein distributing the components further comprises distributing the components across a plurality of resources.

3. The method of claim 1 in which the model has at least two dimensions.

4. The method of claim 2 in which more than one property is applied to an object so as to allow for distribution in which several different constraints apply to that object, each type of property corresponding to a different constraint and causing the object to interact with the other objects which have the same property.

5. The method of claim 1 in which the properties applied to the objects in the model include one or more of: electrostatic charge, magnetic charge and mass.

6. The method of claim 5 wherein at least two of the objects are interconnected by a biasing force.

7. The method of claim 6 wherein the biasing force is applied by a resilient interconnecting member.

8. The method of claim 1 in which at least one of the objects in the model is anchored to a fixed position within the model space.

9. The method of claim 1 in which a type of property applied to an object in the model is chosen according to a type of constraint, and the magnitude of the property applied to the object is chosen according to the actual property of the component on which the constraint is to act.

10. The method of claim 1 in which the property applied to two objects comprises a charge and in which the two objects are given charges of opposite polarity to satisfy a constraint that they are located close to one another in the model space.

11. The method claim 1 in which the property applied to two objects comprises a charge and in which the two objects are given charges of a same polarity to satisfy a constraint that they are to be located far away within the model space.

12. The method of claim 1 in which the magnitude of the property allocated to each object in the model is chosen according to a size of a parameter which is constrained.

13. The method of claim 1 in which the magnitude of the property allocated to each object in the model is chosen according to a significance of a parameter which is constrained.

14. The method of claim 1 in which the resources and constraints comprises at least one selected from a group consisting of:
(i) the resources comprise processing entities having areas of memory and the components comprise computer data which requires memory;
(ii) the resources comprise display regions and the components comprise graphical elements or text or mixed graphics/text that are to be displayed;
(iii) the resources comprise people or devices which can perform work and the components comprise jobs to be performed.

15. A computer program for distributing components across a plurality of resources in which the location of objects is limited by one or more constraints, the program stored on computer-readable medium, the program comprising logic configured to:
provide a model which comprises at least one resource object and at least one component object, each object having at least one property which causes the object to attract or repel other objects, wherein properties allocated to the objects are dependent upon the constraints which apply to distribution of the components across the resources;
distribute the objects within a model space;
allow the objects to move within the model space towards a stable solution; and
distribute the components within the model space according to the distribution of the objects in the model space.

16. A method of allocating portions of data across a network of computer resources, the method comprising:
providing a model of the network of computer resources in which each resource is represented by an object in a space, the model having at least one data object which represents a portion of the data;
determining from the forces exerted on the data object within the space whether the location of the objects is a solution to a problem of distribution; and
in the event that it is a solution, allocating the portion of data to the resources according to the location of the objects in the model.

17. The method of claim 16 which further comprises:
receiving the portion of data;
determining a requirement of a resource required by the data portion; and
modelling the data portion as a data object in which properties allocated to the data object correspond to the required properties of the resources.

18. The method of claim 16 which comprises, after locating the data portion object:
determining if the model is in a stable state; and
(a) in the event that it is in the stable state, allocating the data portion to the resource which corresponds to the resource object closest to the data object in the model space;
(b) in the event that it is not stable, allowing the model to evolve over time such that the objects move towards the stable state and then allocating the data portion to the resource corresponding to the resource object which is closest to the data object in the model space.

19. The method of claim 16 in which the data portion is described by a job request, the job request defining the requirements demanded by a data portion which consists of a sequence of steps that are to be performed by a resource and in which the method is performed by a network administrator or administration device receiving job requests received by a server across a remote network.

20. A computer program for allocating data portions across computer devices connected to form a network of resources stored on computer-readable medium, the program comprising logic configured to:
generate a model of the network of resources in which each resource is represented by an object in a space and the data portion is also modelled as a data object within that space; and
determine, on the basis of the interaction of the objects in the space, whether the location of the data object represents a suitable distribution of the data portion in the network of resources.

21. A method of allocating calls across displays of a call centre, the method comprising:
providing a virtual model in which each display is represented by an object in a multi-dimensional space, the virtual model also including at least one call object which represents a call to a network;
determining from the forces exerted on the call object within the multi-dimensional space whether the location of the call object is a solution to a problem of distribution; and
in the event that it is the solution, allocating the call to the display which corresponds to the display object that is closest to the call object in the virtual model.

22. A call request display apparatus for use by a group of call receivers at a call centre to distribute calls, the apparatus comprising:
a plurality of display screens;
a model of the display screen in which each display screen is represented by a display object in a multi-dimensional space and the call is also modelled as a call object within that space; and
a solution determining means for determining if the location of the call object in the space of displays provides a suitable distribution of the call on the displays.

23. A system of distributing components across a plurality of resources in which the location of objects is limited by one or more constraints, comprising:
means for providing a model which comprises at least one resource object and at least one component object, each object having at least one property which causes the object to attract or repel other objects, wherein properties allocated to the objects are dependent upon the constraints which apply to distribution of the components across the resources;
means for distributing the objects within a model space;
means for allowing the objects to move within the model space towards a stable solution; and
distributing the components within the model space according to the distribution of the objects in the model space.

24. A system of allocating calls across displays of a call centre, the method comprising:
means for providing a virtual model in which each display is represented by a physical object in a multi-dimensional space, the virtual model also including at least one call object which represents a call to a network;
means for determining from the forces exerted on the call object within the space whether the location of the call object is a solution to a problem of distribution; and
means for in the event that it is a solution, allocating the call to the display which corresponds to the display object that is closest to the call object in the virtual model.
